(19) United States
(12) Patent Application Publication
(10) Pub. No.: US 2017/0262944 A1
(43) Pub. Date: Sep. 14, 2017

(54) SOURCE CONTROL RESPONSE SYSTEM AND PROCESS THEREFOR

(71) Applicant: TRENDSETTER ENGINEERING, INC., Houston, TX (US)

(72) Inventor: Michael CARGOL, Houston, TX (US)

(21) Appl. No.: 15/428,845

(22) Filed: Feb. 9, 2017

Related U.S. Application Data
(60) Provisional application No. 62/305,738, filed on Mar. 9, 2016.

(51) Int. Cl. G06Q 50/02; G06Q 10/06; G06Q 30/00; H04L 29/08

(52) U.S. Cl. CPC G06Q 50/02; H04L 67/306; H04L 67/18; H04L 67/10; G06Q 10/063118; G06Q 10/06316; G06Q 30/018

(57) ABSTRACT

A source control response system in which tasks in an event are provided to several persons involved in a response to the event has a plurality of tablet computers provide respectively to the persons involved in the response. Each of the tablet computers is adapted to display a position-specific checklist, incident data and resources. The plurality of tablet computers are interactive with each other. The tablet computers provide details of procedures required by the person. A host computer transmits information as to the existence of the event. A cloud-based network links the host computer to the plurality of tablet computers.

### CROSS-REFERENCE TO RELATED APPLICATIONS

The present application claims priority from U.S. Provisional Patent Application Ser. No. 62/305,738, filed on Mar. 9, 2016, and entitled “Source Control Response System”.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention relates to emergency action plans. More particularly, the present invention relates to systems for responding to incidents that occur in a subsea environment. More particularly, the present invention relates to systems for responding to subsea incidents in which a capping stack is required for use on a subsea blowout.

2. Description of Related Art Including Information Disclosed Under 37 CFR 1.97 and 37 CFR 1.98.

A product known as a “capping stack” has been developed by Trendsetter Engineering, Inc. of Houston, Tex. This capping stack has found widespread use in the subsea environment. The capping stack is an item that can be applied to the blowout preventer in order to prevent the discharge of hydrocarbons into the subsea environment and for the purpose of remedying the problems associated with a defective blowout preventer.

The capping stack is secured to the upper end of the blowout preventer. In the event of a undesired discharge by the blowout preventer, the capping stack can be lowered in place and connected to the upper end of the blowout preventer. The capping stack include suitable valves therein in which the flow from the blowout preventer can be diverted away from the blowout preventer. The capping stack includes a diverter line which extends from a main passageway within the capping stack so as to transmit the hydrocarbons to another location.

This capping stack is the subject of U.S. patent application Ser. No. 13/160,072, filed on Jun. 14, 2011 by the present applicant. This capping stack includes a diverter system for a subsea well that has a blowout preventer and a diverter affixed to an outlet of the blowout preventer. The blowout preventer will have an interior passageway with an inlet of the bottom thereof and an outlet at the top thereof. The diverter has a flow passageway extending therethrough and in communication with the interior passageway of the blowout preventer. The diverter has a valve therein for changing a flow rate of a fluid flowing through the flow passageway. The diverter has at least one channel opening in valved relation to the flow passageway so as to allow the fluid from the flow passageway to pass outwardly of the diverter. At least one flow line is in valved communication with the flow passageway so as to allow fluids or materials to be introduced into the flow passageway.

In conventional use, an oil company will purchase a capping stack and store the capping stack at a desired location. In the event of an incident involving a subsea well, the oil company will transport the capping stack to the incident location and carry out the necessary steps so as to properly attach the capping stack to the blowout preventer. Often, the capping stack will have to be transported hundreds of miles to the desired location. This involves a large number of people and of significant amount of logistics. Additionally, once the capping stack is delivered to the incident location, a variety of procedures are required so as to assemble the capping stack, move the capping stack, and install the capping stack. After installation, several other procedures are required so as to properly implement the capping stack for the purposes of containing the well.

Unfortunately, when such incidents occur, it is often difficult for the oil company to carry out the requisite procedures in the desired manner. In particular, when an incident occurs, a great deal of chaos can result. As a result, the personnel may not have a clear view of their particular responsibilities during the crisis. As such, the implementation of the capping stack can be less efficient than desired. Any confusion during the installation and implementation of the capping stack can result in the discharge of hydrocarbons to the subsea environment for a longer-than-desired period of time. As such, need has developed whereby the capping stack can be efficiently installed and implemented with a minimal amount of confusion.

Currently, a great deal of training is carried out by those companies that purchased the capping stack. The personnel that are required for the installation and implementation of the capping stack are trained in procedures that are required for the purpose of delivering the capping stack from the stored location to the incident location. Unfortunately, such training can be beset with difficulties. For example, the trained personnel may leave their employment. The employee that replaces the trained person may not immediately receive the requisite training so as to carry out the tasks of the trained person. As such, there may be a gap of knowledge of procedures during the incident. In other circumstances, those employees that are sufficiently trained in the installation implementation of the capping stack may forget their specific tasks and responsibilities over time. This has resulted in the need to continually train and retrain personnel in the proper procedures for response during an emergency. As such, a need has developed whereby personnel are effectively informed of their tasks and how to carry out such tasks during the course of an emergency.

Conventionally, user manuals and other information are provided those persons that are assigned responsibilities for implementing the capping stack during the incident. At the time of the emergency, these materials may not be immediately available for such personnel. As such, they must search their records and files in order to find the requisite procedures that are necessary for the installation and implementation of the capping stack. Once again, this can lead to a delay in the proper installation of the capping stack.

During such emergency procedures, the chain-of-command often becomes confused. Certain people will assume responsibilities that are beyond their training. In other circumstances, supervisory personnel may defer to other persons that would appear to have proper knowledge. As such, with the confusion associated during such incidents, the proper chain-of-command for dealing with the incident can be confused. This can further lead to the inability to effectively and efficiently install the capping stack.

In the past, various patents and patent publications have issued with respect to emergency action plans. For example, U.S. Pat. No. 6,741,980, issued on May 25, 2004 to Langseth et al., describes a system and method for automatic, real-time delivery of personalized informational and transactional data to users via a content delivery device. This personal intelligence network actively delivers highly personalized and timely informational and transactional data from an OLAP-based channel database system to individuals via e-mail, spreadsheet programs, pagers, telephone, mobile phone, fax, personal digital assistants, HTML email and other formats.

U.S. Pat. No. 7,584,165, issued on Sep. 1, 2009 to J. G. Buchan, describes a support apparatus method and system for real-time operations and maintenance. This system is intended to facilitate decision-making in connection with management of enterprise assets. A real-time expert decision-support module is interfaced with an access portal including a navigation table for asset management, and with an historical parameter database associated with a distributed control system of sensors and actuated control elements. The access portal and navigation table provides access to tools in the support module that facilitate real-time decision-making information delivery to the functional teams that support an asset, line-of-sight management performance modules of team performance, practical performance analysis tools that extract information in real-time from the process control system, and other sources of asset data for translation into actionable information, and a real-time interactive schematic environment.

U.S. Pat. No. 7,596,608, issued on Sep. 29, 2009 to Alexander et al., discloses a networked emergency management system. This computer-implemented process allows emergency plans to be easily and rapidly created for a plurality of different facilities. The emergency plan is provided in an electronic form for each facility. Each emergency plan has a standardized format with a plurality of component parts. Each emergency plan has at least some component parts that are accessible by other facilities. An electronic network is provided which allows at least some of the facilities to electronically obtain the accessible component parts of the emergency plans of at least some of the other facilities. A user interface allows the emergency plan of a facility to electronically import into its emergency plan selected content of one or more component parts of the emergency plan of another facility in the electronic network.

U.S. Pat. No. 7,096,092, issued on Aug. 22, 2006 to Ramakrishman et al., teaches a method and apparatus for remote real-time oil field management. This method includes the installation of oilfield sensors and coupling them to a local CPU having a memory, programming the CPU for data collection and data analysis, and coupling the local oilfield CPUs to a web server. Human experts are granted access to oilfield data in real-time via the Internet. The local CPUs provide different levels of data to the web server. The web server provides the option to view raw data, partially analyze data, or fully analyze data. The local CPUs are programmed with parameters for analyzing the data and automatically determining the presence of anomalies. Upon detecting the occurrence of an anomaly, the local CPUs are programmed to notify one or more human experts by email, pager, telephone, etc. If no human experts respond to the notification with a programmed period of time, the local CPU automatically takes a program corrective action.

U.S. Pat. No. 8,274,377, issued on Sep. 25, 2012 to Smith et al., shows information collecting and decision-making via a tiered information network system. The system is provided by a tiered network of sensors and communication nodes for security monitoring and warning, disaster warning, counter-written terrorism, and other applications associated with information collecting and decision-making Each command center in a tier network includes a database to store data, a situation awareness module to provide event detection, event forecasting, assessment and response, an analytic module to analyze data characteristics, and a communication module to provide communications with adjacent subordinate and superordinate tier networks.

U.S. Pat. No. 8,601,049, issued on Dec. 3, 2013 to Mendonca et al., teaches a system and method for providing centralized management and distribution of information to remote users. A central server stores information which is maintained at the central server. Periodically, or each time the server information is updated, the server identifies the portion of the information that is relevant to each user and downloads the relevant portion of information to each user and to a mobile device. The system is used to maintain and timely distribute information related to emergency response procedures, sales or servicing schedules, and delivery schedules, among other things.

U.S. Patent Publication No. 2008/0189162, published on Aug. 7, 2008 to Ganong et al., discloses a system to establish and maintain an intuitive command and control of an event. The system is a web-based and phone-based emergency management software system that operates as an intuitive command and control application including a number of integrated software-driven functional processes, common communications devices and services, and an enterprise database of key emergency-necessitated information. The system interactively serves an organization's first responders, administrators and agents, emergency management teams, and a number of other key internal and external stakeholders.

U.S. Patent Publication No. 2012/0260313, published on Oct. 11, 2012 to H. Gomez, discloses a digital system and method for building emergency and disaster plan implementation. The emergency and disaster preparedness system is hosted on a computer system with a secure network interface using a terminal or user interface to the system that communicates through the network interface. A security management module for user authentication connects an authenticated user into the system. A communications module provides and sets active alerts for all users. An administrative console provides management of system functions. A learning management system is operable from the system and incorporates a plurality of function specific databases for user information on the building structure content and environment. A portable emergency response tool operates independently or through the network interface. The emergency response tool has a portion of the plurality of function specific databases integrally stored thereon and functions specifically for use by first responders separate from the communicating with the overall system.

U.S. Patent Publication No. 2013/0013523, published on Jan. 10, 2013 to O. S. Herrera Campos, shows a system and method for disaster preparedness. The system includes an emergency preparedness system having a dynamic checklist tool configured to use a master checklist to produce a plant-specific checklist based on a selection of at least one emergency event. It produces actionable articles have in at least one emergency preparedness recommendation for a plant.

It is an object of the present invention to provide a source control response system that enables external data transfer and communications through secure cloud-based networks.

It is another object of the present invention to provide a source control response system that allows consolidation, external certification and dissemination of critical well specific data that is specific to well control and response preparedness.

It is another object of the present invention to provide a source control response system that enhances response preparedness in the event of an incident.

It is another object of the present invention to provide a source control response system that enhances the ability to control the well.

It is another object of the present invention to provide a source control response system that is user friendly.

It is another object of the present invention to provide a source control response system that provides guidance in order to keep responders on task.

It is a further object of the present invention to provide a source control response system that provides position specific task links and technical information.

It is a further object of the present invention to provide a source control response system that is easy to navigate.

It is another object of the present invention to provide a source control response system that facilitates the transaction of a response from a reactive state to a proactive state.

It is another object of the present invention to provide a source control response system that allows for efficient response in the event of an emergency.

It is a further object of the present invention to provide a source control response system that allows immediate access to technical and operational well information.

It is a further object the present invention to provide a source control response system that facilitates interactive exercises and drills.

It is a further object of the present invention to provide a source control response system that is secure.

It is still another object of the present invention to provide a source control response system that promotes collaboration and communications in the event of an incident.

These and other objects and advantages of the present invention will become apparent from a reading of the attached specification and appended claims.

### BRIEF SUMMARY OF THE INVENTION

The present invention is a source control response system in which the tasks required in the event of an incident are provided to each of the personnel involved in the response to the incident. In particular, the details of procedures that are required by each of the personnel is maintained on tablet hardware, such as an iPad. Each person involved in the response to the incident is provided with a separate tablet. In particular, each of the tablets will include a position specific checklist, incident data, and resources.

In particular, the position specific checklists provides an initial response task list, daily task lists, hyperlinks to keep data required to complete each task, calendar tools and communication tools. The incident data will include a well file that is linked to a “WELL CHECK”™ file. The incident data can also include status updates. The various resources that are incorporated include the company's response plan in an eBOOK™ format with hyperlinks, contact lists, organizational charts with roles and responsibilities (proscriptive), reporting processes, health, safety and environmental compliance guidance, and procedures (e.g. generic procedures for reference).

In normal use, the source control response system of the present invention is particularly configured for the implementation of a capping stack in the event of an offshore incident, such as a blowout. In particular, each person involved with the responses is provided with a separate tablet. The tablet will provide visual guidance of the procedures required of that person in order to implement the necessary procedures. The tablet can also provide information to the various users as to the status of the well, the flow rate of the well, the subsea conditions, and other factors. For example, when it is required to transport the capping stack from a stored location to the incident location, the tablet will inform the user of the proper phone numbers to contact and persons to contact in order to properly deliver the capping stack. The person involved at the storage facility will then have the necessary information on the tablet as to which shipping company to use, the phone number of the shipping company, and the name of the key person at the shipping company. As such, immediate arrangements can be provided for the shipment of the capping stack to the incident location. At the incident location, the tablet can informed the person of the necessary procedures for preparing the capping stack at the incident site and for the delivery of the capping stack to the subsea environment. In all cases, the present invention provides an interactive procedure whereby each person involved in the process will be able to know when the task has been completed and when their responsibility during the incident will be required.

The present invention is also a process for responding to an event that includes the steps of: (1) providing a plurality of tablet computers to a respective plurality of persons; (2) transmitting a signal to the plurality of tablet computer so as to notify the plurality of persons of the event; (3) displaying person-specific tasks on the tablet computer relative to the event; (4) sending data to the plurality of persons related to the event; and (5) displaying the sent data on the tablet computer.

This process of the present invention further includes storing a position-specific checklist on the tablet computer. The position specific checklist has an initial response task list, a daily task list, hyperlinks, calendar tools and communication tools. The resources are stored on the tablet computer. In particular, the resources comprise a response plan.

The process of the present invention further includes storing an emergency response file on a server. The transmitted signal is the emergency response file. In particular, the emergency response event can be an offshore well blowout. In this circumstance, the data includes well status, well flow rate, and subsea conditions. In particular, the process of the present invention contacts an offshore person regarding equipment required for the event, delivers the equipment from an onshore location to the offshore well blowout location, and installs the equipment so as to resolve the offshore well blowout. Ultimately, a notification is sent from the offshore well blowout location that the installation is complete.

The step of transmitting being through a secure cloud-based network. Update information is transmitted to the plurality of persons on a periodic basis. The transmitted signals to the plurality of persons is encrypted.

This foregoing Section is intended describe, with particularity, the preferred embodiments of the present invention. It is understood that modifications to these preferred embodiments can be made within the scope of the appended claims. As such, the Section should not be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a block diagram showing the source control response system of the present invention.

FIG. 2 is a block diagram showing the display of information on the tablet computer as a result of a source control response system and, in particular, as associated with a well blowout.

### DETAILED DESCRIPTION OF THE INVENTION

The source control response system of the present invention utilizes familiar tablet hardware in order to integrate traditional hardcopy emergency action plans with the latest in software application technologies. As such, the present invention provides a user-friendly tool that equips key response personnel with the tools necessary to provide guidance in order to keep responders on task during the critical periods of the response. The source control response system of the present invention incorporates the emergency response plan of a particular company with position specific task lists and technical information appropriate for each specific response position. The user-friendly application is easy to navigate and operate even for the most unskilled of iPad or computer users. The source control response system of the present invention facilitates the transaction of a response from reactive to proactive in the most efficient manner possible.

The source control response system of the present invention increases the utility of the application by providing data management and secure real-time communications for responders through the use of a secure cloud-based network. The users will have the ability to immediately access the necessary technical and operational well information needed to conduct the response in a safe, efficient and cost-effective manner. The source control system of the present invention facilitates interactive exercises in drills through the use of well scenario packages that are developed. As such, personnel can practice and exercise the response prior to the occurrence of an incident. The well scenario package includes initial data and periodic updates which simulate an actual well event and the responses. The serves to increase the level of realism and learning.

The source control response system of the present invention allows customization based upon the particular requirements of a company. The source control system of the present invention provides automatic updates so as to ensure that all responders are utilizing the latest version of the emergency action plan of the company at all times.

The tablet used in the present invention has a dashboard designed to facilitate ease-of-use and navigation. The home screen is a navigatable organization chart and has a table of contents with links and a TOC hot tab. The tablet provides a customizable color scheme with the client logo. The tablet can include snapshot status reports. Extensive use of hyperlinks are provided within the system. This serves to reduce the file size and make it less complex. There is an automatic update when on Wi-Fi so as to ensure that all data is up-to-date and consistent across the response.

The system of the present invention is secured by having a user-specific login. The system operates through secure cloud-based network. The data transmission records are also encoded or encrypted so as to provide security.

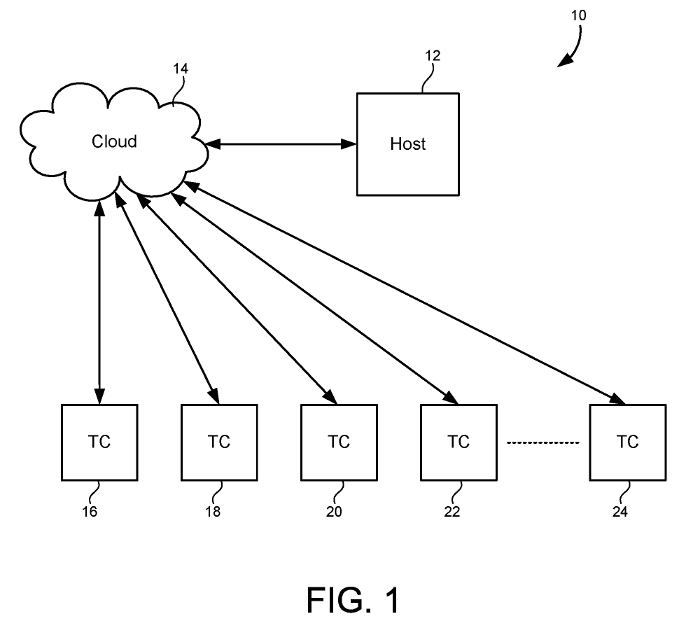

FIG. 1 shows the source control response system of the present invention. In particular, there is a host computer 12 that communicates with a secure cloud-based network 14. The plurality of tablet computers 16, 18, 20, 22 and, 24 all are interactive with the secure cloud-based network 14. As such, since each of the tablet computers 16, 18, 20, 22 and 24 has a user-specific login, each of the tablet computers can communicate with the information provided by the host computer 12 to the cloud-based network 14. In particular, the host computer 12, for example, can be at the headquarters of an oil company. The headquarters has received information pertaining to an offshore blowout. Immediately, the host computer, which has the emergency response plan therein, can send a signal to the cloud-based network so that the various persons associated with tablet computers 16, 18, 20, 22 and 24 can be notified as to the existence of the event. At that point in time, each of the tablet computers 16, 18, 20, 22 and 24 will display information to the person associated with such tablet computer the details associated with the emergency response.

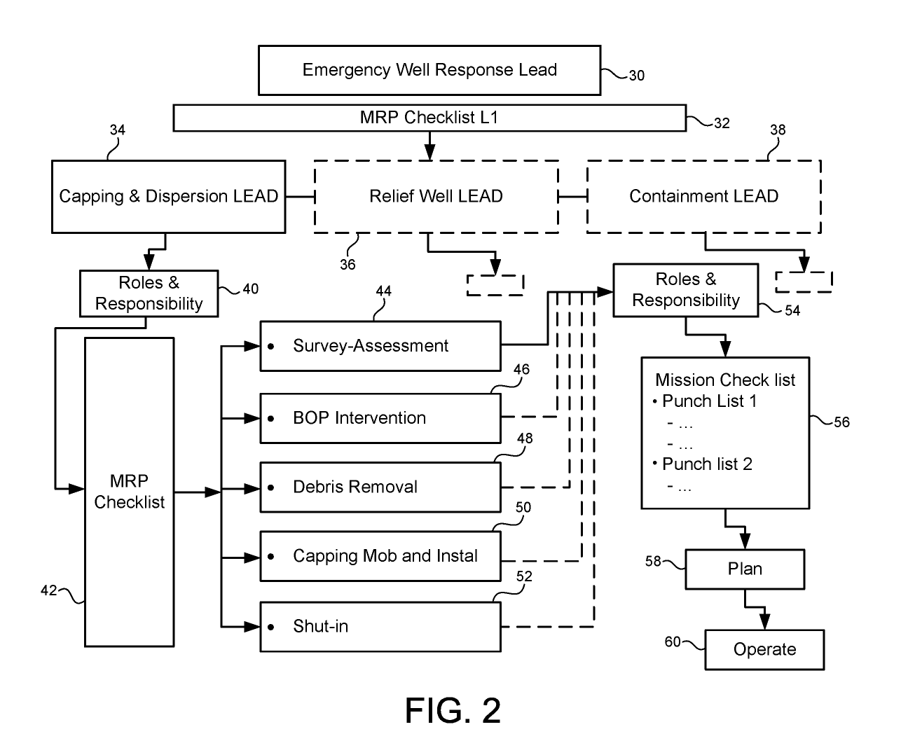

In particular, FIG. 2 shows the information that is provided to the tablet computers. An emergency well response lead 30 is associated with a checklist 32. Checklist 32 directs information to the capping and dispersion lead 34, the relief well lead 36, and the containment lead 38. The capping and dispersion lead 34 will be that group of persons responsible for obtaining a capping stack and installing the capping stack. If further action in the containment of the offshore blowout is required, then the capping and dispersion lead 34 will send a signal to the relief well lead 36 so that the relief well can become operational. The relief well lead 34 will also receive the checklist 32 so that the tasks required for preparing the relief 12 will be immediately available to the relief well lead. Ultimately, if further action is required after either the capping stack fails to stop the blowout or the relief well fails to stop the blowout, then a signal can be transmitted from either the capping and dispersion lead 34 or the relief well lead 36 to the containment lead 38 to the effect that further action is necessary. At that time, the containment lead 38 can receive the checklist 32 from the emergency well response lead 30.

For the purposes of illustration, the information provided from the capping and dispersion lead will include roles and responsibilities 40. These roles and responsibilities are person-specific tasks related to the installation, acquisition, delivery, and installation of the capping stack. A checklist 42 is then set forth and delivered to the survey and assessment personnel 44, the blowout preventer intervention personnel 46, the debris removal personnel 48, the capping mobilization and installation personnel 50, and the shut-in personnel 52. The checklist 40 can be delivered on a scheduled basis so that the first step in the emergency response is the survey and assessment of the blowout conditions. After the survey and assessment is completed, then the blowout preventer intervention personnel can take the necessary steps so as to address the condition of the blowout preventer. The various activities with can be on a scheduled basis relative to task completion during the offshore event. When it is determined that a capping stack is appropriate for the resolution of the well blowout, the capping mobility and installation personnel 50 are notified. The checklist 42 can provide information such as the location of the capping stack, the transport companies that can mobilize the capping stack, the installation ships that are available in the area of for installing the capping stack, and ROV operators available for the placement of the capping stack on the wellhead or the blowout preventer.

FIG. 2 further shows that each of the survey and assessment personnel 44, the blowout preventer intervention personnel 46, the debris removal personnel 48, the capping stack mobilization and installation personnel 50 and the shut-in personnel 52 have information pertaining to the roles and responsibilities 54 of the various persons within each of these groups. A mission checklist 56 is then specifically provided on the tablet computers to each person in such a group. This mission checklist 56 includes various punch lists. A plan 58 and an operate 60 are also provided to each of the persons relative to their particular roles and responsibilities.

The source control system of the present invention promotes collaboration and communication between the personnel. Real-time status updates are provided to managers. An integrated calendar is provided having meeting requests and conflict alerts. The system includes a messaging capability within the application. Notes can be made by typing or writing with a stylus in a “notes section”. File-sharing capabilities provided by a dropbox utility.

The source control system of the present invention expedites transition from a reactive to a proactive response. Interactive checklists are provided for the initial response. Additionally, interactive task list are maintained for sustained response. The system has immediate access to “WELL CHECK”™ files and technical data.

The source control system of the present invention improves training, drills and exercises. Interactive exercises are provided through the creation and use of various SIM files. There is an increased level of realism for responders so that they stay engaged throughout the exercise. The performance is tracked and reported to facilitate the constant improvement process for the user.

The content of the source control system of the present invention has position specific checklists and organizational tools. In particular, these position specific checklists and organization tools includes an initial response task list. Daily task lists are also provided to the user. This can include calendar and updated incident action plans. Hyperlinks to key data required to complete each task are also provided amongst the daily task lists. The position specific checklists and organization tools also includes calendar tools and communication tools.

The source control system of the present invention also provides incident data to the user. This incident data can include a well file and status updates. Resources are also provided. These resources include the company's response plan in a eBOOK format with hyperlinks, contact lists, organizational charts with roles and responsibilities, reporting processes, health, safety and environmental compliance guidance, and various other procedures.

The present invention incorporates an online service for providing immediate information as to the nature of the well and the conditions associated with the well. This is an online service that is designed and implemented as a result of demands from operators to provide a simplified method for well integrity and source control operations review and planning. The secure cloud-based network provides a customized website for submittal, processing, tracking, receipt and storage of large data files. The portal allows for an operator's staff to submit data based on a digital checklist that ensures that the process is consistent, efficient and comprehensive. Once all necessary data has been submitted, a notification is sent to engineering so as to flag the file for immediate review and start the clock for a fourteen day processing cycle. If, during the review, the items are tagged, then an immediate notification is sent to an operator so that additional information can be obtained and the issue can be resolved in a timely manner. Once the review has been completed, the operator receives a certification with an independent professional engineer stamp. Both review criteria and certification documentation can be customized based on internal client requirements for external regulatory requirements. With the “WELL CHECK PLUS”™ system, only raw data needs to be supplied. The well check staff will handle the rest. The well check personnel coordinate the processing and modeling of all supplied data. Such modeling can include well integrity modeling, relief well plans, and interface modeling. The final product is a well check certification package which is uploaded to the engineer for internal records or well applications as deemed appropriate by the operator.

This creates an emergency response file that is stored on the server. This file is kept secure unless an incident involving that location occurs. In the event of an incident, designated company personnel can release the well file which then immediately links to the source control system of the present invention so as to enable immediate dissemination of critical information to the key response personnel. The system is highly customizable based upon the specific requirements of the operator.

The well information that is provided in the source control response system of the present invention can include a well summary, well modeling/planning, rig equipment, contingency response, regional OSRP, regional source control response plans, dispersants, debris removal equipment, capping, containment, site control, along with signatures and approvals. The well summary is a summary of proposed changes and modifications. A summary sheet is provided with location, WCD rate and content, MAWP, classification, map, etc. The well summary can also include wellbore schematics. The well modeling/planning can include a worst-case discharge model, a relief well plan, at a well classification tool. The rig equipment can include rig spec sheets and capabilities, riser spec sheets, OCTG spec sheets, and a BOP/LMRP analysis. The BOP/LMRP analysis will further include drawings, configurations, controls, details of operations, a mechanical interface check (i.e. capping stack-BOP-wellhead), an interface drawing, and shear confirmation. The capping information can include the designated stack, the configuration drawing, a confirmation of the interface and the connectors are available, and a CFD check (within and equipment design or new analysis). The containment includes process flow diagrams and models and a listing of equipment providers. The Site Control can include in-water plume modeling and a surface gas dispersion model.

The foregoing disclosure and description of the invention is illustrative and explanatory thereof. Various changes in the details of the described system can be made within the scope of the present claims without departing from the true spirit of the invention. The present invention should only be limited by the following claims and their legal equivalents.

I claim:

1. A source control response system in which tasks required in an event are provided to several persons involved in a response to the event, the source control response system comprising:
a plurality of tablet computers provided respectively to the persons involved in the response, each tablet computer of said plurality of tablet computers adapted to display a position specific checklist, incident data and resources, said plurality of tablet computers being interactive with each other, said plurality of tablet computers providing details of procedures required by the person in the response to the event;
a host computer that communicates with said plurality of tablet computers, said host computer transmitting information as to an existence of the event; and
a cloud-based network linking said host computer to said plurality of tablet computers.

2. The source control response system of claim 1, the position specific checklist comprising and an initial response list, a daily task list, hyperlinks to data required to complete a task of the daily task list, calendar tools and communication tools.

3. The source control response system of claim 1, the incident data comprising a well file and a status update.

4. The source control response system of claim 1, the resources selected from the group consisting of: hyperlinks, contact list, organizational charts, reporting processes, health compliance procedures, safety compliance procedures, environmental compliance procedures, and combinations thereof.

5. The source control response system of claim 1, said host computer providing updates to said plurality of tablet computers.

6. The source control response system of claim 1, each of said plurality of tablet computers having a user-specific login.

7. The source control response system of claim 1, the transmitted information being encoded.

8. The source control response system of claim 1, said host computer comprising a server that transmits the information only after the event.

9. The source control response system of claim 1, the resources selected from the group consisting of a well summary, well modeling, rig equipment, dispersants, debris removal equipment, capping, containment, site control, signatures, approvals, and combinations thereof.

10. A process for responding to an event, the process comprising:
providing a plurality of tablet computers to a respective plurality of persons;
transmitting a signal to said plurality of tablet computers so as to notify the plurality of persons of the event;
displaying person-specific tasks on the tablet computer relative to the event;
sending data to the plurality of persons related to the event; and
displaying the sent data on the tablet computer.

11. The process of claim 10, further comprising:
storing a position-specific checklist on the tablet computer.

12. The process of claim 11, said position-specific checklist having an initial response task list, a daily task list, hyperlinks, calendar tools, communication tools, and combinations thereof.

13. The process of claim 10, further comprising:
storing resources on the tablet computer, said resources comprising a response plan.

14. The process of claim 10, further comprising:
storing an emergency response file on a server, the transmitted signal being the emergency response file.

15. The process of claim 10, the event being an offshore well blowout, the data being a well status, a well flow rate, and subsea conditions.

16. The process of claim 15, further comprising:
contacting an onshore person regarding equipment required for the event;
delivering the equipment from an onshore location to the offshore well blowout locations; and
installing the equipment so as to resolve the offshore well blowout.

17. The process of claim 16, further comprising:
sending a notification from the offshore well blowout location that the installation is complete.

18. The process of claim 10, the step of transmitting being through a secure cloud-based network.

19. The process of claim 10, further comprising:
transmitting update information to said plurality of persons on a periodic basis.

20. The process of claim 10, further comprising:
encrypting the transmitted signals to the plurality of persons.
